(19) United States
(12) Patent Application Publication
(10) Pub. No.: US 2017/0032295 A1
(43) Pub. Date: Feb. 2, 2017

(54) HUMAN AND ORGANIZATIONAL RESILIENCE MATRIX

(71) Applicant: Siemens Energy, Inc., Orlando, FL (US)

(72) Inventors: Wesley A. Witt, Orlando, FL (US); Jeffrey P. Conkwright, Orlando, FL (US)

(21) Appl. No.: 15/097,367

(22) Filed: Apr. 13, 2016

Related U.S. Application Data
(60) Provisional application No. 62/199,315, filed on Jul. 31, 2015.

(51) Int. Cl. G06Q 10/06

(52) U.S. Cl. CPC G06Q 10/0633; G06Q 10/0635

(57) ABSTRACT

A method for designing a resilient organizational process includes determining a failure event, identifying one or more factors that the failure event is attributable to, analyzing the identified factors to determine a corrective process step for each factor, and mapping each of the corrective process steps to occupy a specific coordinate in a corrective action matrix. A first coordinate axis of the matrix represents organizational domains and a second coordinate axis of the matrix represents resilient system characteristics. The organizational domains include workplace, work and worker. The resilient system characteristics include anticipation, monitoring, responding and learning.

### CROSS REFERENCE TO RELATED APPLICATIONS

This application claims priority to the U.S. provisional application No. 62/199,315 filed Jul. 31, 2015, which is incorporated by reference herein in its entirety.

### BACKGROUND

1. Field

The present invention relates generally to resilient engineering and human performance tools to manage organizational risk. Specific embodiments relate to a method for designing a resilient organizational process and an organizational method for investigating an incident.

2. Description of the Related Art

The term “resilience” has been used to describe a movement among entities such as businesses, communities and governments to improve their ability to respond to and quickly recover from catastrophic events. Resilience Engineering deals with developing tools and methods for both system developers and people responsible for the maintenance and management of system safety, in a number of industries.

The implementation of Resilience Engineering and Human Performance Tools and practices to manage individual and organizational risk to prevent error likely situations from leading to loss events is an emerging science in industries including power generation, medical, aviation and many other industries and business models. Academia has proven the characteristics of highly reliable organizations that implement these practices to create processes that reduce injuries, decrease organizational risk and increase production and efficiency.

However, in the state of the art, a systematic and standardized process of implementation has not yet been defined for the consistent, sustainable and repeatable implementation of this science. Until this point, the problem of not having a system for implementation has not been addressed by industry or academia. Academia has provided research on the characteristics and concepts of Resilience Engineering and highly reliable organizations. For example, the book “Resilience Engineering in Practice” by Erik Hollnagel, MINES ParisTech, France, Jean Pariès, Dédale SA, France, David Woods, Ohio State University, USA and John Wreathall, John Wreathall & Co., USA, teaches that the continued development of resilience engineering has focused on four abilities that are essential for resilience, namely a) to respond to what happens, b) to monitor critical developments, c) to anticipate future threats and opportunities, and d) to learn from past experience—successes as well as failures.

However, no process has been developed to date to create or duplicate these concepts into action within an organization. Currently, the only way for an organization to be proficient at these items is to have an employee become deeply involved in the science, spending years studying and developing practices in this area.

### SUMMARY

Briefly, aspects of the present invention provide a method for designing a resilient organizational process and an organizational method for investigating an incident.

In a first aspect, a method for designing a resilient organizational process is provided. The method includes determining a failure event, identifying one or more factors that the failure event is attributable to, analyzing the identified factors to determine a corrective process step for each factor, and mapping each of the corrective process steps to occupy a specific coordinate a corrective action matrix. A first coordinate axis of the matrix represents organizational domains and a second coordinate axis of the matrix represents resilient system characteristics. The organizational domains include workplace, work and worker. The resilient system characteristics include anticipation, monitoring, responding and learning.

In a second aspect, an organizational method for investigating an incident is provided. The method includes determining a timeline of events leading up to the incident. From the timeline of events, one or more factors are identified that the event is attributable to. The method further includes analyzing the identified factors to map each identified factor to a specific coordinate in an organizational resilience matrix. A first coordinate axis of the matrix represents organizational domains and a second coordinate axis of the matrix represents resilient system characteristics. The organizational domains include workplace, work and worker. The resilient system characteristics include anticipation, monitoring, responding and learning.

### BRIEF DESCRIPTION OF THE DRAWINGS

The invention is shown in more detail by help of figures. The figures show preferred configurations and do not limit the scope of the invention.

FIG. 1 is a diagram illustrating domains of an organization according to one embodiment,

FIG. 2 is a diagram illustrating an organizational resilience matrix according to one embodiment of the present invention,

FIG. 3 is a flowchart illustrating an exemplary method for designing a resilient organizational process, according to one embodiment,

FIG. 4 is a diagram illustrating a sequence of events leading up to an incident according to an example embodiment,

FIG. 5 is a diagram illustrating factor analysis according to one embodiment, and

FIG. 6 is a diagram illustrating a corrective action analysis matrix according to one embodiment.

### DETAILED DESCRIPTION

Embodiments of the present invention illustrate a human and organizational resilience matrix, the design and implementation of which solves an unfulfilled need to create a systematic process of implementation for any industry to apply the concepts of Resilience Engineering to reduce loss, increase efficiency and increase safety to employees and organizations.

It is known from Resilience Engineering that in order for an organization to be resilient, it must be able to respond to what happens, monitor critical developments, anticipate future threats and opportunities and learn from past experiences. The present technique is built on the identification of the above-noted four characteristics of a resilient system, namely, anticipation, monitoring, responding and learning. Anticipation refers to the ability to plan ahead for a crisis or an adverse incident. Monitoring refers to the ability to monitor, for example, not only anticipated factors but also unforeseen factors. Responding refers to the ability to act in response to the monitored factors, particularly in a crisis or an adverse incident. Learning refers to the ability to learn from past experiences, both successes and failures, which would further feed into the ability to anticipate. An inventive feature of the present technique is to use the above noted resilient system characteristics, namely anticipation, monitoring, responding and learning in systematically designing and implementing organizational processes, which has not been attempted so far.

The present technique is also based on the recognition that an organization works on not one but multiple levels of human systems, referred to herein as organizational domains. A further inventive feature of the present technique lies in the fact it applies the principles of resilience engineering across multiple domains of the organization to develop highly resilient human implemented processes.

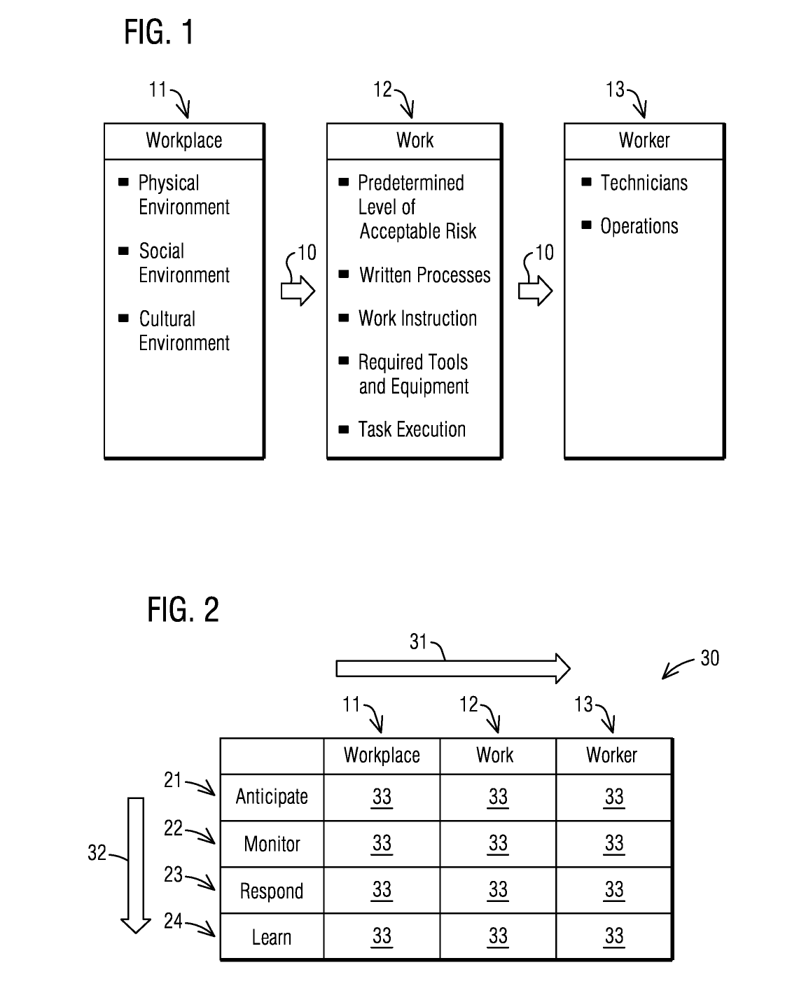

As shown in FIG. 1, the organizational domains may include workplace 11, work 12 and worker 13. The arrows 10 indicate the flow of business within the organization.

The workplace domain 11 is typically defined by the senior management or executive management of the organization, and may include, for example, the physical environment, social environment and cultural environment. The physical environment may include, for example, the geographic location of the worksite, and conditions of the worksite such as temperature, pressure, humidity etc. The social environment may include, for example, contractors, plant managers, customers, etc. The cultural environment may include, for example, communication modes, attitude of worksite, etc.

The work domain 12 is defined typically by the middle management or back office engineering staff and may include, for example, predetermined levels of acceptable risk, written processes, work instructions, required tools and task execution. The processes and tools in the work domain 12 are developed within the framework of the workplace 11 defined by the executive management.

The processes and tools defined in the work domain 12 are handed over to the worker domain 13. The worker domain 13 may include both, technicians or frontline workers, as well as operations.

The present technique is based on the application of the principles of Resilience Engineering across every domain of the organization to develop highly resilient and robust human implemented organizational processes. According to the present technique, an organizational process may be developed to map on to each of the resilient system characteristics such as anticipation, monitoring, responding and learning across each of the organizational domains, namely workplace, work, and work. To this end, the present technique is based on the development and use of an organizational resilience matrix.

FIG. 2 illustrates an organizational resilience matrix 30. The matrix 30 is defined by first and second coordinate axes 31 and 32. The first coordinate axis 31 represents the organizational domains workplace 11, work 12 and worker 13. The second coordinate axis 32 represents the resilient system characteristics anticipate 21, monitor 22, respond 23 and learn 24. The coordinate axes 31 and 32 define a plurality of mapping coordinates 33, in this case, twelve in number.

The organizational resilience matrix based methodology may be used, for example, in the event of a failure or an adverse incident, to map a cause or a factor to a specific mapping coordinate 33 in the matrix 30. For example, it may be determined, using the organizational resilience matrix, that an incident was caused by a failure of a worker to anticipate, or a by failure of a work process to monitor, or a combination of the above. The failure factors may be then analyzed to determine corrective action or process steps, not only for the respective coordinates associated with the factors identified, but for other unaddressed areas of the matrix, to develop a robust and resilient process that minimizes organizational risk. In another aspect, the organizational resilience matrix may be used to determine how vulnerable an organizational process is to failure, and to use this knowledge to design a robust and resilient organizational process.

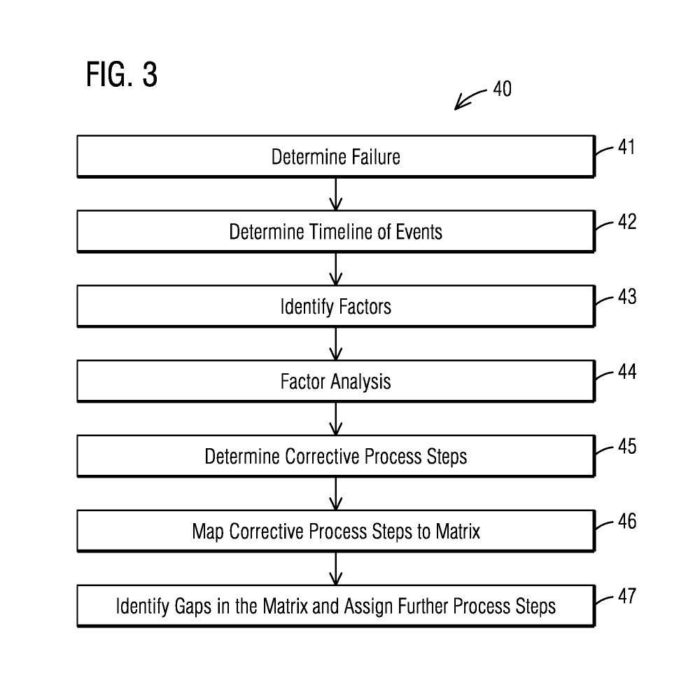

FIG. 3 is a flowchart describing an exemplary method 40 for designing a resilient organizational process. In this example, the process is designed in response to a failure event determined at step 41, which, for example, may be a fire at a factory site. The failure may be determined, for example, by monitoring tools and processes already in place.

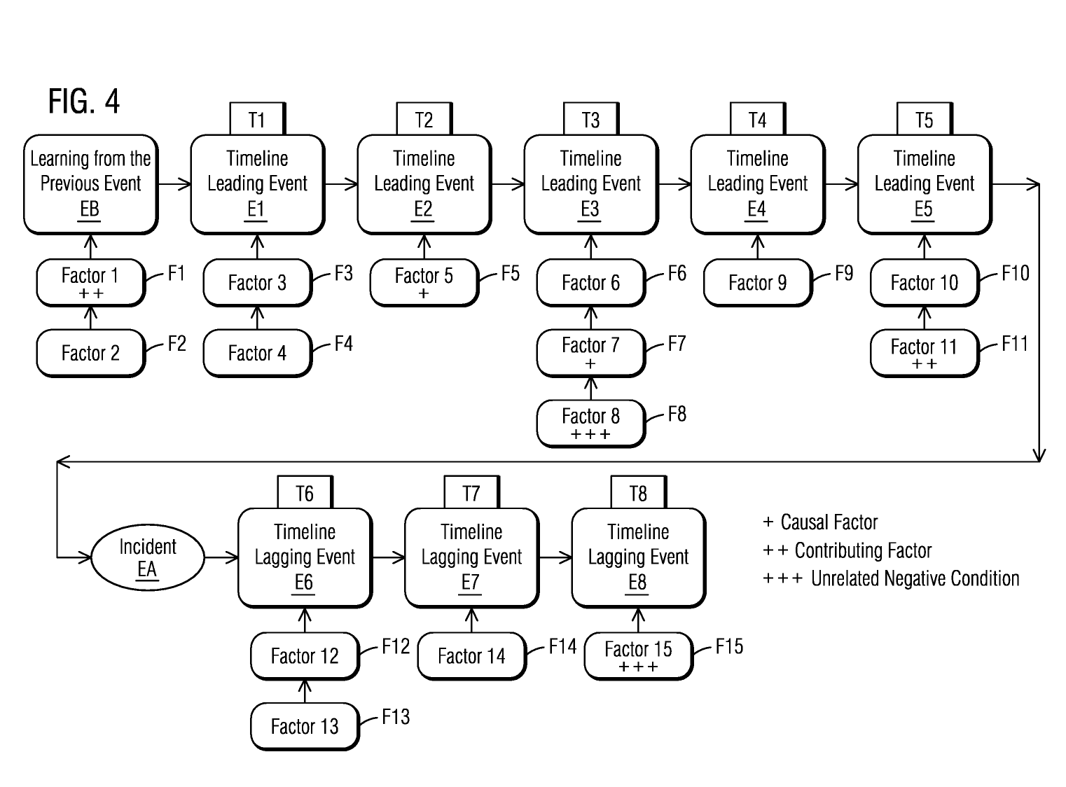

Subsequent to determining a failure event, one or more failure factors are identified, to which the failure event may be attributed. In the present example, in order to identify failure factors, a timeline is developed at step 42 for events leading up to (and possibly beyond) the failure event. An example of such a timeline 50 for the present case is illustrated in FIG. 4. As shown therein, the timeline 50 includes a sequence of events E1, E2, E3, E4 and E5 occurring respectively at times T1, T2, T3, T4 and T5 leading up to a failure event EA. The events E6, E7 and E8 occur respectively at times T6, T7 and T8 following the failure event EA. The event EB refers to a past failure of a similar nature. From the timeline of events, failure factors may be identified (step 43 in FIG. 3). In the example of FIG. 4, the identified failure factors are designated F1 to F15.

Referring back to FIG. 3, the next step 44 involves factor analysis. This step may include, for example analyzing the identified factors to map each identified factor to a specific coordinate in the organizational resilience matrix described in FIG. 2. Such a mapping may be used to determine areas of vulnerability in the matrix that need corrective actions.

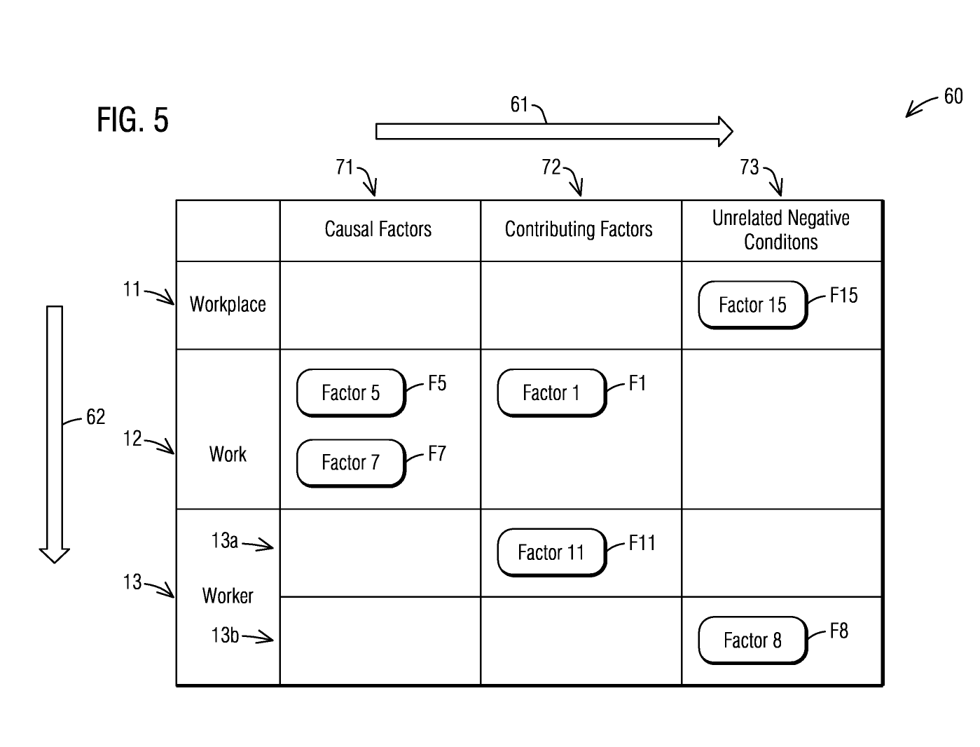

The step of factor analysis may also involve a mapping of failure factors as shown in FIG. 5. In this example, a factor analysis matrix 60 is developed which includes axes 61 and 62. Along the axis 60, the failure factors are classified based on type, namely causal factors 71, contributing factors 72 and unrelated negative conditions 73. Along the axis 62, the failure factors are mapped to organizational domains workplace 11, work 12 and worker 13. As shown, the worker domain 13 may be further divided into sub-domains 13a and 13b which represent operations and technicians respectively. In the present example, based on the timeline of events, factors F5 and F7 are determined to be causal factors 71, which map to the domain work 12. The factors F1 and F11 are determined to be contributing factors 72, which are mapped respectively to the domain work 12 and the domain worker 13 (specifically the sub-domain operations 13b). The factors F15 and F8 are determined to be unrelated negative conditions 73, which are mapped respectively to the domain workplace 11 and the domain worker 13 (specifically the sub-domain technicians 13b).

Referring back to FIG. 3, at step 45, based on the factor analysis, a corrective action or process step is determined to specifically address each failure factor identified at step 43. Then, at step 44, each of the corrective actions or process steps are mapped on to a matrix that is based on the inventive concept described in FIG. 2.

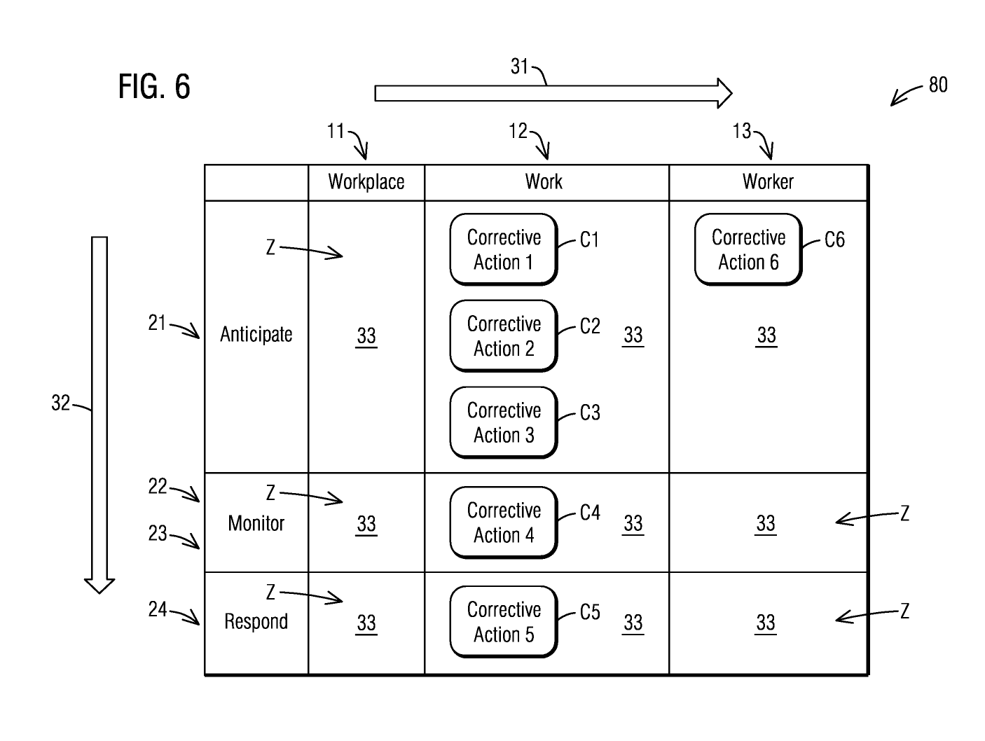

FIG. 6 illustrates a corrective action matrix 80. The matrix 80 is essentially an organizational resilience matrix onto which corrective actions or process steps are mapped. As illustrated, the matrix 80 is defined by first and second coordinate axes 31 and 32. The first coordinate axis 31 represents the organizational domains workplace 11, work 12 and worker 13. The second coordinate axis 32 represents the resilient system characteristics anticipate 21, monitor 22, respond 23 and learn 24. The coordinate axes 31 and 32 define a plurality of mapping coordinates 33. Each of the corrective actions or process steps determined at step 43 are mapped to a specific coordinate in the matrix 80. The corrective process steps in turn follow from the failure factors identified in FIG. 5.

It will be seen that in the present example, the corrective actions identified from the failure factors largely indicate a vulnerability of the work (i.e., work processes or tools) to anticipate the failure event. Accordingly, the corrective actions or process steps C4, C5, C6 are assigned to the coordinate 33 that relates to the anticipation 21 capability of the work domain 12. However, the present technique may be utilized to go beyond determining corrective process steps only for identified failure factors. For example, the matrix 80 in FIG. 6 indicates several unaddressed areas indicated by unoccupied coordinates 33 (identified as Z) in the matrix 80, which may leave the organization vulnerable to future failure events. Accordingly, in a further aspect of the present technique, the mapping of process steps into the matrix 80 may be used to identify vulnerability of the organization, for example by identifying unoccupied coordinates in the matrix 80.

Referring back to FIG. 3, the method 40 for designing an organizational process may further include a step 47 involving identifying one or more gaps in the corrective action matrix, and assigning one or more process steps that map on to the identified gaps in the corrective action matrix. In the example of FIG. 6, process steps C4, C5 and C6 are further assigned to the organizational process, which are designed to address monitoring and responding capabilities of the work 12 and the anticipating capability of the worker 13. The present example poses still further possibilities to improve the process by addressing, for example, gaps or unoccupied coordinates in the worker domain.

The inventive concept can thus be used as much for incident investigation as for design of a resilient organizational processes. Such a resilient organizational process may be designed, for example, at the domain of work but may be implemented across other domains of the organization. The illustrated embodiments provide a systematic framework to create systems and enable people to action within the concepts of Resilience Engineering to produce low risk and more efficient work designed around the fallibility of humans to reduce the amount of error likely situations, trap errors that do occur and increasing the likelihood of a successful outcome. Organizational practices may be designed around the inventive matrix to produce communication, training, processes, tooling and procedures to decrease the likelihood that human error can lead to an unwanted event, thereby improving reliability of the organization. The inventive matrix makes the implementation of the concepts of Resilience Engineering simple and allows laymen to work with such concepts almost immediately upon training. The organization of ideas into the matrix further makes it possible to understand resilience as a system, measure systems in place and plan for future actions in resilience from a common background.

While specific embodiments have been described in detail, those with ordinary skill in the art will appreciate that various modifications and alternative to those details could be developed in light of the overall teachings of the disclosure. Accordingly, the particular arrangements disclosed are meant to be illustrative only and not limiting as to the scope of the invention, which is to be given the full breadth of the appended claims, and any and all equivalents thereof.

What is claimed is:

1. A method for designing a resilient organizational process, comprising:
determining a failure event,
identifying one or more factors that the failure event is attributable to,
analyzing the identified factors to determine a corrective process step for each factor, and
mapping each of the determined corrective process steps to occupy a specific coordinate in a corrective action matrix defined by first and second coordinate axes, the first coordinate axis representing organizational domains and the second coordinate axis representing resilient system characteristics,
wherein the organizational domains comprise workplace, work and worker, and
wherein the resilient system characteristics comprise anticipation, monitoring, responding and learning.

2. The method according to claim 1, further comprising:
identifying one or more gaps in the corrective action matrix, and
assigning one or more process steps that map on to the identified gaps in the corrective action matrix.

3. The method according to claim 2, wherein the one or more gaps correspond to unoccupied coordinates in the corrective action analysis matrix.

4. The method according to claim 1, further comprising mapping each of the identified factors map to a specific coordinate in an organizational resilience matrix defined by first and second coordinate axes, the first coordinate axis representing organizational domains and the second coordinate axis representing resilient system characteristics,
wherein the organizational domains comprise workplace, work and worker, and
wherein the resilient system characteristics comprise anticipation, monitoring, responding and learning.

5. The method according to claim 1, wherein the workplace includes a physical environment of the organization.

6. The method according to claim 1, wherein the workplace includes a social environment of the organization.

7. The method according to claim 1, wherein the workplace includes a cultural environment of the organization.

8. The method according to claim 1, wherein the work includes written processes and/or work instructions.

9. The method according to claim 1, wherein the worker includes technicians and/or operations.

10. An organizational method for investigating an incident, comprising:
determining a timeline of events leading up to the incident,
from the timeline of events, identifying one or more factors that the event is attributable to, and
analyzing the identified factors to map each identified factor to a specific coordinate in an organizational resilience matrix defined by first and second coordinate axes, the first coordinate axis representing organizational domains and the second coordinate axis representing resilient system characteristics,
wherein the organizational domains comprise workplace, work and worker, and
wherein the resilient system characteristics comprise anticipation, monitoring, responding and learning.

11. The method according to claim 10, wherein analyzing the identified factors further comprises grouping the identified factors into one of the categories selected from the list consisting of: causal factors, contributing factors and unrelated negative conditions.

12. The method according to claim 11, wherein analyzing the identified factors further comprises grouping the identified factors into one of the organizational domains.

13. The method according to claim 10, wherein the workplace includes a physical environment of the organization.

14. The method according to claim 10, wherein the workplace includes a social environment of the organization.

15. The method according to claim 10, wherein the workplace includes a cultural environment of the organization.

16. The method according to claim 10, wherein the work includes written processes and/or work instructions.

17. The method according to claim 10, wherein the worker includes technicians and/or operations.
